(19) United States
(12) Patent Application Publication
(10) Pub. No.: US 2014/0005853 A1
(43) Pub. Date: Jan. 2, 2014

(54) METHOD AND SYSTEM FOR MONITORING ELECTRICAL LOAD OF ELECTRIC DEVICES

(71) Applicants: Hung-Yuan Chen, Hsinchu County (TW); Chien-Liang Lai, Hsinchu County (TW); Lun-Chia Kuo, Taichung City (TW)

(72) Inventors: Hung-Yuan Chen, Hsinchu County (TW); Chien-Liang Lai, Hsinchu County (TW); Lun-Chia Kuo, Taichung City (TW)

(73) Assignee: INDUSTRIAL TECHNOLOGY RESEARCH INSTITUTE, Hsinchu (TW)

(21) Appl. No.: 13/590,203

(22) Filed: Aug. 21, 2012

(30) Foreign Application Priority Data
Jun. 27, 2012 (TW) 101123013

(51) Int. Cl. G05F 5/00

(52) U.S. Cl. 700/298

(57) ABSTRACT

A method and a system for monitoring electric devices coupled to a power circuit are provided. The method includes: obtaining a first power feature of the power circuit at a time; obtaining a second power feature of the power circuit at another time; determining whether a power feature variation occurs according to the first and second power features. If the power feature variation occurs, the method further includes: adjusting the first power feature to a first normalized power feature according to a reference voltage; adjusting the second power feature to a second normalized power feature according to the reference voltage; recognizing that a status of one of the electric devices is changed from a first status to a second status according to the first and second normalized power features. By applying the method, whether the electric devices are switched on or off may be accurately recognized.

### CROSS-REFERENCE TO RELATED APPLICATION

This application claims the priority benefit of Taiwan application serial no. 101123013, filed on Jun. 27, 2012. The entirety of the above-mentioned patent application is hereby incorporated by reference herein and made a part of this specification.

### BACKGROUND

1. Technical Field

The disclosure relates to a method and a system for monitoring an electrical load of electric devices.

2. Related Art

Due to the concern for energy conservation, installation of smart meters and configuration of advanced metering infrastructure (AMI) have become more and more popular. The AMI may replace the conventional manual metering reading mechanism as well as improve efficiency of utilizing electric energy. According to researches, a user may spontaneously reduce the power use if he or she may be aware of the total power consumption in the household. Moreover, if the user may learn how much energy goes into each of the appliances within his or her home, the user may further figure out a way to effectively save energy.

According to a conventional intrusive load monitoring technique, a sensor is installed in each electric device (appliance), so as to learn whether each electric device is switched on or off. Alternatively, a nonintrusive appliance load monitoring (NALM) technique may be applied to detect the total power consumption of all electric devices and then determine the electric devices that are switched on or the electric devices that are switched off. Attention of people skilled in the pertinent art has been attracted to the way to accurately determine the on or off state of each electric device by employing the nonintrusive monitoring technique.

### SUMMARY

One of exemplary embodiments discloses a method and a system for monitoring an electrical load of electric devices. By applying the method or the system, whether the electric device is turned on or off may be accurately recognized.

In an exemplary embodiment of the disclosure, a method for monitoring a plurality of electric devices is provided, and the electric devices are coupled to a power circuit. The method includes: obtaining a first power feature of the power circuit at a first time; obtaining a second power feature of the power circuit at a second time different from the first time; determining whether a power feature variation occurs according to the first power feature and the second power feature; performing a recognition process if the power feature variation occurs. The recognition process includes: adjusting the first power feature to a first normalized power feature according to a reference voltage; adjusting the second power feature to a second normalized power feature according to the reference voltage; recognizing that a status of a first electric device of the electric devices is changed from a first status to a second status according to the first normalized power feature and the second normalized power feature.

In an exemplary embodiment of the disclosure, a method for monitoring an electric device is provided. The electric device is coupled to a power circuit, and the power circuit is coupled to a power supply. The power supply serves to supply power to the electric device. The method includes: obtaining a power feature of the power circuit through a power feature meter; determining a type of the power feature meter; determining a type of the power supply according to a location of the power supply; adjusting the power feature according to the type of the power feature meter, the type of the power supply, and a reference voltage, so as to generate a normalized power feature; recognizing the electric device according to the normalized power feature.

In an exemplary embodiment of the disclosure, a system for monitoring a plurality of electric devices is provided. The system is coupled to a power circuit, and the electric devices are coupled to the power circuit. The system includes a power feature extraction module, an event detection module, a power feature normalization module, and an electric device status recognition module. The power feature extraction module serves to obtain a first power feature of the power circuit at a first time and obtain a second power feature of the power circuit at a second time different from the first time. The event detection module is coupled to the power feature extraction module for determining whether a power feature variation occurs according to the first power feature and the second power feature. The power feature normalization module is coupled to the event detection module. If the power feature variation occurs, the power feature normalization module adjusts the first power feature to a first normalized power feature according to a reference voltage and adjusts the second power feature to a second normalized power feature according to the reference voltage. The electric device status recognition module recognizes that a status of a first electric device of the electric devices is changed from a first status to a second status according to the first normalized power feature and the second normalized power feature.

In an exemplary embodiment of the disclosure, a system for monitoring an electric device coupled to a power circuit is provided. The electric device is coupled to the power circuit, and the power circuit is coupled to a power supply. The power supply serves to supply power to the electric device. The system includes a power feature extraction module, a power feature normalization module, and an electric device status recognition module. The power feature extraction module serves to obtain a power feature of the power circuit through a power feature meter and determine a type of the power feature meter. The power feature normalization module is coupled to the power feature extraction module for determining a type of the power supply according to a location of the power supply and adjusting the power feature according to the type of the power feature meter, the type of the power supply, and a reference voltage, so as to generate a normalized power feature. The electric device status recognition module is coupled to the power feature normalization module for recognizing the electric device according to the normalized power feature.

As described above, the method and the system for monitoring the electric device may normalize the measured power feature and further accurately recognize and monitor whether the electric device is turned on or off.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1A is a schematic diagram monitoring an electrical loads of electric devices is monitored according to a first exemplary embodiment of the disclosure.

FIG. 1B is a block diagram illustrating a system for monitoring an electrical load according to the first exemplary embodiment of the disclosure.

FIG. 1C is a schematic diagram illustrating an operation of the power feature meter according to the first exemplary embodiment of the disclosure.

FIG. 2 is a curve diagram illustrating an active power variation according to the first exemplary embodiment of the disclosure.

FIG. 3 is a flowchart illustrating a method for monitoring an electrical load of electric devices according to the first exemplary embodiment of the disclosure.

FIG. 4 is a schematic diagram illustrating three-phase electric power according to a second exemplary embodiment of the disclosure.

FIG. 5 is a schematic diagram illustrating single-phase electric power according to the second exemplary embodiment of the disclosure.

FIG. 6 is a flowchart illustrating a method for monitoring an electrical load of an electric device according to the second exemplary embodiment of the disclosure.

FIG. 7 is a schematic diagram illustrating extraction of the power features from different locations according to the second exemplary embodiment of the disclosure.

### DETAILED DESCRIPTION OF DISCLOSED EXEMPLARY EMBODIMENTS

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### First Exemplary Embodiment

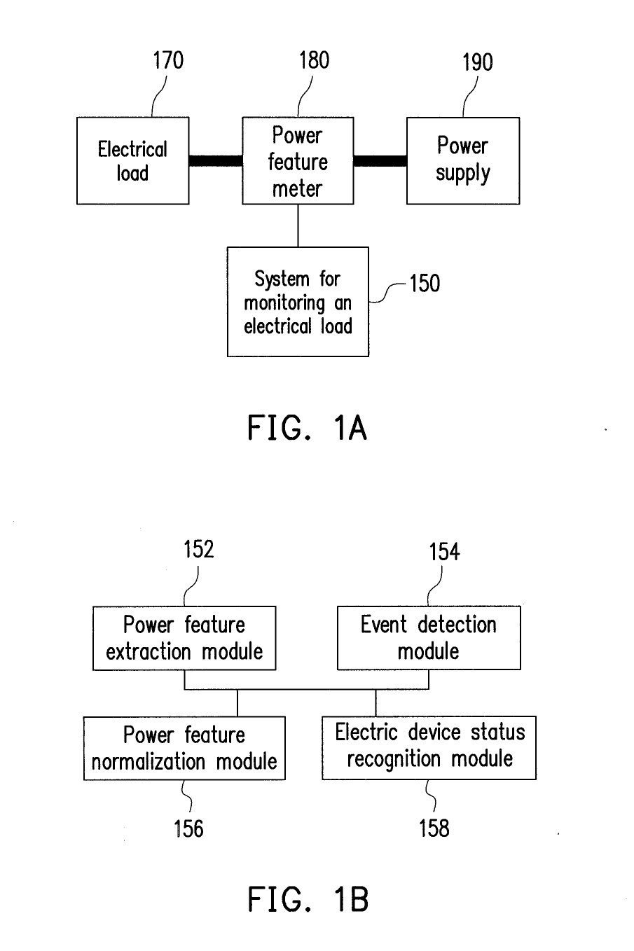

FIG. 1A is a schematic diagram monitoring an electrical load of electric devices according to a first exemplary embodiment of the disclosure.

A power supply 190 is configured to supply power to one or more electric devices. The power supplied by the power supply 190 may be an alternating current or a direct current, and the power supply 190 may provide single-phase electric power, two-phase electric power, or three-phase electric power, which should not be construed as limitations to the disclosure.

A power feature meter 180 is coupled to the power supply 190 for measuring a power feature of one electric device or power features of plural electric devices. In the present exemplary embodiment, the power feature measured by the power feature meter 180 is active power. However, the power feature meter 180 may also measure a voltage, a current, a reactive power, a power factor, an apparent power, a current waveform, or a harmonic wave, which should not be construed as a limitation to the disclosure.

An electrical load 170 is coupled to the power feature meter 180. For instance, the electrical load 170 includes one or more power circuits, and each of the power circuits is coupled to one or more electric devices. The electric devices coupled to the power circuits are operated by the power supplied by the power supply 190.

The system 150 for monitoring the electrical load 170 is coupled to the power feature meter 180, and thereby the system 150 obtains the power feature of the electrical load 170 and further determines the specific electric device having the status change in the electrical load 170. For instance, the system 150 obtains the total power of all the electric devices in the electrical load 170 and determines the specific electric device that is turned on (or turned off).

FIG. 1B is a block diagram illustrating a system for monitoring an electrical load according to the first exemplary embodiment of the disclosure.

With reference to FIG. 1B, the system 150 includes a power feature extraction module 152, an event detection module 154, a power feature normalization module 156, and an electric device status recognition module 158.

The power feature extraction module 152 is configured to obtain the power feature measured by the power feature meter 180.

The event detection module 154 is coupled to the power feature extraction module 152 and configured to determine whether a power feature variation occurs according to the power feature extracted by the power feature extraction module 152. For instance, the power feature extraction module 152 constantly extracts the power feature of the electrical load 170. When a difference between the previously extracted power feature and the presently extracted power feature is greater than a threshold value, the event detection module 154 identifies that the power feature variation occurs.

The power feature normalization module 156 is coupled to the power feature extraction module 152 and the event detection module 154. The power feature normalization module 156 is configured to normalize the power feature extracted by the power feature extraction module 152 when the power feature variation occurs.

The electric device status recognition module 158 is coupled to the power feature normalization module 156 and the event detection module 154. The electric device status recognition module 158 is configured to recognize a specific electric device having a status change according to the normalized power feature generated by the power feature normalization module 156.

FIG. 1C is a schematic diagram illustrating an operation of the power feature meter according to the first exemplary embodiment of the disclosure.

The electrical load 170 includes the power circuit 120 that is coupled to the electric devices 102, 104, and 106. In the present exemplary embodiment, the electrical load 170 is applied in the normal household. The electric device 102 is a screen, the electric device 104 is audio equipment, and the electric device 106 is a refrigerator. Nevertheless, it should be understood that the disclosure is not limited thereto. For instance, in another exemplary embodiment, the electrical load 170 may be applied in a factory or in a business building, and the electric devices may be a mechanical arm, a server, or an elevator.

The power circuit 120 includes sub-power circuits 122, 124, and 126. In the present exemplary embodiment, the sub-power circuits 122, 124, and 126 are sockets, and the electric devices 102, 104, and 106 are coupled to the sub-power circuits 122, 124, and 126. Namely, the electric devices 102, 104, and 106 obtain the power supplied by the power supply 190 through the power circuit 120. In other exemplary embodiments, the sub-power circuits 122, 124, and 126 may be an extended line, a transformer, or a rectifier, which should not be construed as a limitation to the disclosure.

The power feature meter 180 includes a multiplexer 110, sensors 112, 114, and 116, an alternating current (AC)/direct current (DC) circuit 130, a microcontroller 140, and a communication transmission output interface 160.

The sensor 112 is coupled to the sub-power circuit 122, the sensor 114 is coupled to the sub-power circuit 124, and the sensor 116 is coupled to the sub-power circuit 126. For instance, the sensors 112, 114, and 116 are analog (or digital) electric meters for respectively measuring the power features (i.e., the sub-power features) of the sub-power circuits 122, 124, and 126.

The multiplexer 110 is coupled to the sensors 112, 114, and 116 and the microcontroller 140.

The AC/DC circuit 130 is coupled to the power supply 190. The AC/DC circuit 130 is configured to convert the power supplied by the power supply 190 into power adapted to the power feature meter 180 and supply the converted power to the microcontroller 140.

The microcontroller 140 is configured to measure the power feature of the power circuit 120. To be specific, the multiplexer 110 in turn couples the sensors 112, 114, and 116 to the microcontroller 140, and the microcontroller 140 sequentially obtains the sub-power features measured by the sensors 112, 114, and 116.

The communication transmission output interface 160 is coupled to the microcontroller 140. Through network, radio frequency communication, or any other wire or wireless transmission, the communication transmission output interface 160 transmits data and information generated by the microcontroller 140 to the system 150. In an exemplary embodiment, the system 150 is configured on a remote server. The electric device status recognition module 158 offers use management (e.g., an application program) to the electric devices 102, 104, and 106. A user may connect the server for the use management through a communication device (e.g., a personal computer, a cell phone, or a tablet PC) and further monitor each of the electric devices 102, 104, and 106.

In another exemplary embodiment, the system 150 may be installed at home, and the communication transmission output interface 160 may transmit data to the system 150 through a cable or a bus, which should not be construed as a limitation to the disclosure.

The power feature extraction module 152 obtains the power feature measured by the power feature meter 180. To be specific, the power feature extraction module 152 may obtain the power feature of the power circuit 120 according to the sub-power features obtained from the sub-power circuits 122, 124, and 126. For instance, the sub-power features are the active power of the sub-power circuits 122, 124, and 126. After adding the active power of the sub-power circuits 122, 124, and 126 together, the power feature extraction module 152 may obtain the total active power consumed by the power circuit 120. However, the sub-power features may include a voltage, a current, a reactive power, a power factor, an apparent power, a current waveform, or a harmonic wave, which should not be construed as a limitation to the disclosure.

To be specific, the power feature extraction module 152 obtains a power feature (i.e., the first power feature) of the power circuit 120 at a time (i.e., the first time). At another time (i.e., the second time), the power feature extraction module 152 obtains another power feature (i.e., the second power feature) of the power circuit 120. The event detection module 154 determines whether a power feature variation occurs according to the first power feature and the second power feature. If the power feature variation occurs, the power feature normalization module 156 normalizes the first power feature and the second power feature according to a reference voltage. Besides, the electric device status recognition module 158 recognizes a status change of one electric device according to the normalized power feature.

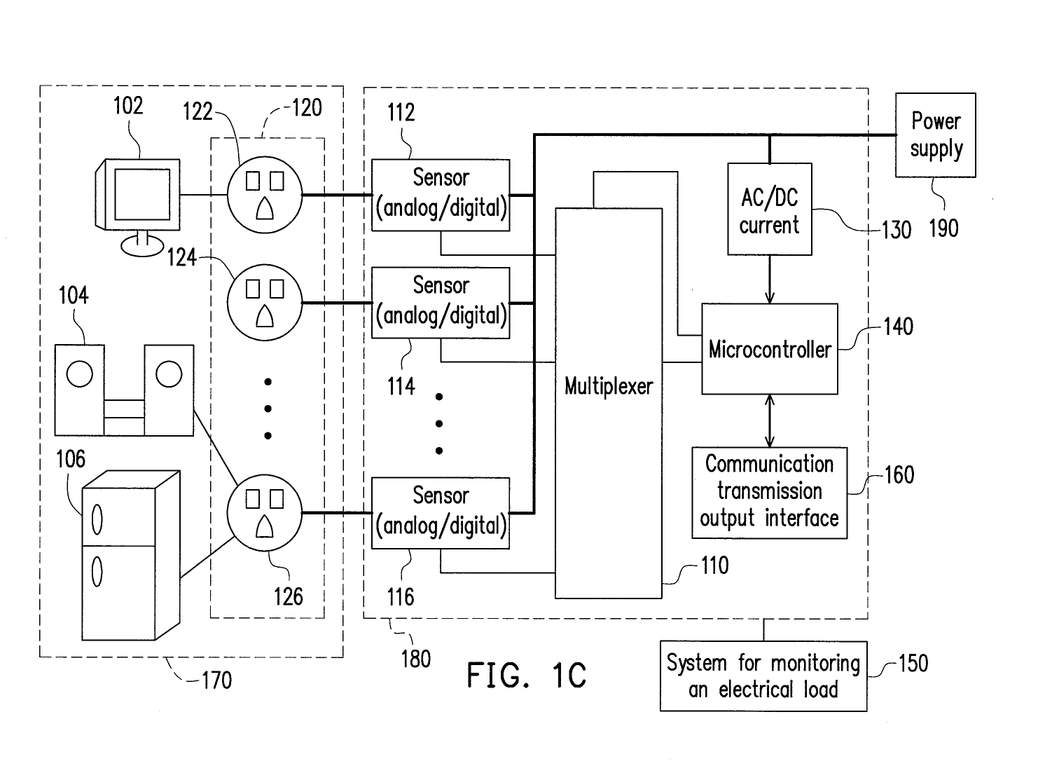

FIG. 2 is a curve diagram illustrating an active power variation according to the first exemplary embodiment of the disclosure.

With reference to FIG. 2, the horizontal axis represents time, and the vertical axis represents the total active power (in unit of watt) consumed by the power circuit 120. For instance, during the time period 210, the electric device 102 is switched on, and the electric device 104 is switched off At this time, the active power measured by the power feature meter 180 is 826.4 watts, and the voltage is 119.3 volts. During the time period 220, both the electric devices 102 and 104 are switched on; at this time, the active power measured by the power feature meter 180 is 1340 watts, and the voltage is 117.9 volts. During the time period 230, the electric device 102 is switched off, and the electric device 104 is switched on; at this time, the active power measured by the power feature meter 180 is 557.2 watts, and the voltage is 120.2 volts. Note that the difference between the active power (1340 W) consumed during the time period 220 and the active power (557.2 W) consumed during the time period 230 is 782.8 watts because the electric device 102 is switched off during the time period 230. However, if only the electric device 102 is switched on, the consumed active power is 826.4 watts. The two numeric values of the consumed active power (782.8 watts and 826.4 watts) are not equal. Since the electric device 104 is switched off during the time period 210 but is switched on during the time period 220, which leads to a voltage drop from 119.3 V to 117.9 V and also results in the fact that the active power consumed by the electric device 102 during the time period 220 is less than the active power consumed by the electric device 102 during the time period 210.

Therefore, the voltage may not remain unchanged at different time points, which may pose an impact on the active power consumed by one electric device at different time points. In the present exemplary embodiment, the power feature normalization module 156 sets a reference voltage and adjusts active powers measured at different voltages to active powers referred to the reference voltage. For instance, at a certain time point, the total active power Pₚᵣₑ of the power circuit 120 may be expressed by formula (1).

$${P}_{pre} = {\sum }_{j = 1}^{i} {( \frac{{V}_{1}}{{V}_{normal}} )}^{α} \cdot {P}_{j} \qquad ( 1 )$$

Here, it is assumed that there are N electric devices A₁˜A_{N} (e.g., the electric devices 102, 104, and 106), Pⱼ refers to the active power consumed by the electric device Aⱼ at the reference voltage, and the presently switched-on electric devices are A₁˜Aᵢ. α is the power feature factor and is a constant. V₁ is the voltage at this time point, and Vₙₒᵣₘₐₗ is the reference voltage. The formula (1) may be re-written as formula (2) presented below.

$${{P}_{pre} ( \frac{{V}_{normal}}{{V}_{1}} )}^{α} = {\sum }_{j = 1}^{i} {P}_{j} \qquad ( 2 )$$

At another time point, the total active power Pₙₑₓₜ of the power circuit 120 may be expressed by formula (3).

$${P}_{next} = {\sum }_{j = 1}^{i} {( \frac{{V}_{2}}{{V}_{normal}} )}^{α} \cdot {P}_{j} + {( \frac{{V}_{2}}{{V}_{normal}} )}^{α} \cdot {P}_{x} \qquad ( 3 )$$

At this time point, the voltage is V₂. Aₓ is the newly switched-on electric device, and the active power consumed by the electric device Aₓ at the reference voltage is Pₓ. The formula (3) may be re-written as formula (4) presented below.

$${{P}_{next} ( \frac{{V}_{normal}}{{V}_{2}} )}^{α} = {\sum }_{j = 1}^{i} {P}_{j} + {P}_{x} \qquad ( 4 )$$

Formula (5) may be obtained by subtracting the formula (2) from the formula (4) or subtracting the formula (4) from the formula (2).

$${P}_{x} = {{P}_{next} ( \frac{{V}_{normal}}{{V}_{2}} )}^{α} - {{P}_{pre} ( \frac{{V}_{normal}}{{V}_{1}} )}^{α} \qquad ( 5 )$$

That is, if the active powers (i.e., the active power Pₙₑₓₜ next and the active power Pₚᵣₑ) measured at two time points are normalized and then subtracted from each other, the active power Pₓ consumed by the electric device Aₓ at the reference voltage may be obtained. In an exemplary embodiment, the system 150 may establish a database that stores the active power (i.e., an electric device normalized power feature) of each of the electric devices at the reference voltage. Hence, by comparing the active power Pₓ to the active power of each of the electric devices stored in the database, the system 150 may recognize that the electric device Aₓ is switched on between said two time points. Nonetheless, in another exemplary embodiment, Pₙₑₓₜ next and Pₚᵣₑ may refer to reactive power or apparent power, and the database may record the reactive power or the apparent power of each of the electric devices at the reference voltage.

For instance, with reference to FIG. 2, at the time T1, the power feature extraction module 152 obtains the active power (i.e., the first power feature, 1340 W) and the voltage (i.e., the first voltage, 117.9 V) of the power circuit 120 through the power feature meter 180. At the time T2, the power feature extraction module 152 obtains the active power (i.e., the second power feature, 557.2 W) and the voltage (i.e., the second voltage, 120.2 V) of the power circuit 120 through the power feature meter 180. The event detection module 154 obtains the difference between the active power measured at the time T1 and the active power measured at the time T2 and thereby determines if the difference is greater than a threshold value. For instance, the threshold value may be set as 20, which should not be construed as a limitation to the disclosure. If said difference exceeds the threshold value, the event detection module 154 determines that the power feature variation occurs. This represents that the status of certain electric device may have been changed, and at this time the power feature normalization module 156 and the electric device status recognition module 158 perform a recognition process.

In the recognition process, the power feature normalization module 156 generates the first normalized power feature according to the first power feature (1340 W), the first voltage (117.9 V), and the reference voltage. Particularly, the power feature normalization module 156 adjusts the first power feature according to the reference voltage (e.g., 120 V). At the time T1, for instance, the power feature normalization module 156 first obtains a ratio (i.e., a first ratio) of the first voltage (117.9 V) to the reference voltage (120 V). The power feature normalization module 156 then obtains a power feature factor α. In the exemplary embodiment, the power feature factor α is 2, for instance, which should not be construed as a limitation to the disclosure. The power feature normalization module 156 then performs an exponential computation according to the first ratio and the power feature factor α. Eternally, the power feature normalization module 156 multiplies a result of the exponential computation by the first power feature (1340 W) to generate the normalized power feature (i.e., the first normalized power feature). That is, the power feature normalization module 156 calculates that the first normalized power feature corresponding to the first power feature is 1388.16 W according to the formula (2). Here, the first normalized power feature refers to the total active power of all the electric devices which are switched on at the time T1 at the reference voltage.

The power feature normalization module 156 also generates the second normalized power feature according to the second power feature (557.2 W), the second voltage (120.2 V), and the reference voltage. Particularly, the power feature normalization module 156 adjusts the second power feature according to the reference voltage (e.g., 120 V). At the time T2 for instance, the power feature normalization module 156 first obtains a ratio (i.e., a second ratio) of the second voltage (120.2 V) to the reference voltage (120 V). The power feature normalization module 156 then obtains the power feature factor α (which equals 2 in the present exemplary embodiment). The power feature normalization module 156 then performs the exponential computation according to the second ratio and the power feature factor α. Eternally, the power feature normalization module 156 multiplies a result of the exponential computation by the second power feature (557.2 W) to generate the normalized power feature (i.e., the second normalized power feature). That is, the power feature normalization module 156 calculates that the second normalized power feature corresponding to the second power feature is 552 W according to the formula (2). Here, the second normalized power feature refers to the total active power of all the electric devices which are switched on at the time T2 at the reference voltage.

During the time period 210, the active power of the electric device 102 at the reference voltage is 836.13 W(=825.4×((120/119.3)̂2)).

Note that the difference between the first normalized power feature (1388.16 W) and the second normalized power feature (552 W) is 836.16 W, which is very much close to the active power (836.13 W) of the electric device 102 at the reference voltage. By comparing the two numeric values of the active power, the electric device status recognition module 158 may recognize that the status of the electric device 102 is changed from an on status (i.e., a first status) to an off status (i.e., a second status). Alternatively, the electric device status recognition module 158 records the active power of the electric device 120 at the reference voltage in the database and recognizes the status of the electric device 102 by accessing the database, which should not be construed as a limitation to the disclosure.

In other exemplary embodiments, the aforesaid method may be applied to recognize the status of another electric device. Besides, the first status may refer to an off status, and the second status may refer to an on status. Alternatively, the first status and the second status may represent different operation modes of one electric device. For instance, given that the electric device is a hair drier, the first status may refer to a low-speed mode, and the second status may refer to a high-speed mode. The disclosure should not be construed as limited to the embodiments set forth herein.

In the previous exemplary embodiment, the power feature factor α is a constant 2. However, in other exemplary embodiments, each electric device may have different power feature factors. The power feature normalization module 156 may obtain the power feature factor of each of the electric devices through performing a regression analysis.

Taking the electric device 102 (i.e., the second electric device) as an example, the power feature extraction module 152 may obtain a plurality of power features (i.e., measured power features) and a plurality of voltages (i.e., measured voltages) of the electric device 102 through the power feature meter 180. Here, the power feature refers to the active power, for instance. The power feature normalization module 156 establishes a regression model according to one of the measured power features, one of the measured voltages, the reference voltage, a regression power feature of the electric device 102, and the power feature factor. The regression model may be expressed by formula (6) below, for instance.

$$p = {p}_{norm} \cdot {( \frac{V}{{V}_{ref}} )}^{α} \qquad ( 6 )$$

Here, p refers to one of the measured power features, V refers to one of the measured voltages, V_{ref} denotes the reference voltage, pₙₒᵣₘ refers to a regression power feature of the electric device 102, and a refers to the power feature factor of the electric device 102. For instance, pₙₒᵣₘ represents the active power of the electric device 102 at the reference voltage. In the formula (6), there are two unknown variables (pₙₒᵣₘ and α). This means that at least two measured voltages and at least two measured power features are required for performing the regression analysis. However, the number of the measured voltages and the number of the measured power features are not limited in the disclosure. The power feature normalization module 156 may then perform the regression analysis based on the established regression model, the measured power features, and the measured voltages. Thereby, the power feature normalization module 156 may obtain the power feature factor and the regression power feature of the electric device 102. For instance, after the regression analysis is performed, the power feature factor α of the electric device 102 obtained by the power feature normalization module 156 is 3.1 rather than 2 stipulated in the Ohm's Law. Hence, in different electric devices, the power feature normalization module 156 may apply the calculated power feature factor for accurately calculating the normalized power feature of each electric device. Note that Pₙₒᵣₘ and P in the formula (6) may be reactive power or apparent power, which should not be construed as a limitation to the disclosure.

It should be mentioned that the regression analysis described above is performed by the system 150. However, in other embodiments, the regression analysis may be performed by a computer system (not shown) in advance. The computer system may store the calculated power feature factor into a database. The system 150 may then obtain the power feature factor of each electric device by accessing the database, which should not be construed as a limitation to the disclosure.

Even though the power feature extraction module 152, the event detection module 154, the power feature normalization module 156, and the electric device status recognition module 158 are implemented in form of hardware according to the present exemplary embodiment, note that the disclosure is not limited thereto. For instance, in another exemplary embodiment, the system 150 may include a central processing unit (CPU) and a memory. Here, the functions of the power feature extraction module 152, the event detection module 154, the power feature normalization module 156, and the electric device status recognition module 158 may be implemented in form of program codes, the program codes may be stored in the memory, and the CPU is capable of executing the program codes to achieve the function of monitoring the electrical load of the electric device as provided herein.

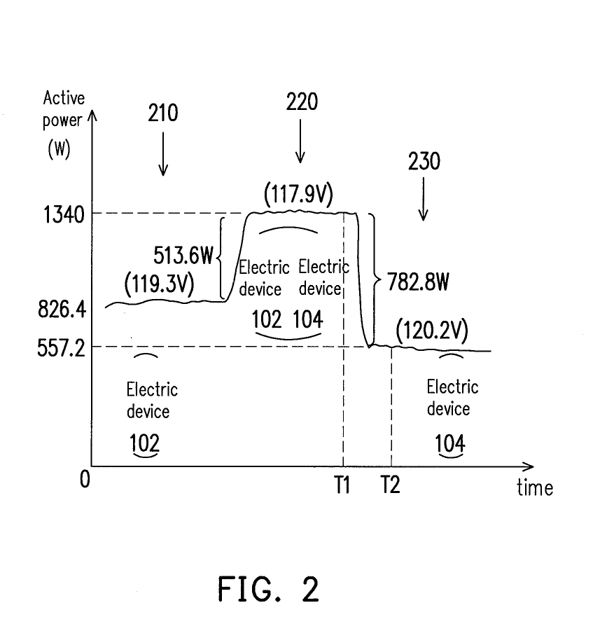

FIG. 3 is a flowchart illustrating a method for monitoring an electrical load of electric devices according to the first exemplary embodiment of the disclosure.

With reference to FIG. 3, in step S302, the power feature extraction module 152 obtains a first power feature of the power circuit at a certain time. In step S304, the power feature extraction module 152 obtains a second power feature of the power circuit at another time. In step S306, the event detection module 154 determines whether a power feature variation occurs according to the first power feature and the second power feature.

If no power feature variation occurs, the steps illustrated in FIG. 3 are terminated.

If the power feature variation occurs, the power feature normalization module 156 in step S308 adjusts the first power feature to a first normalized power feature according to a reference voltage, and the power feature normalization module 156 in step S310 adjusts the second power feature to a second normalized power feature according to the reference voltage.

In step S312, the electric device status recognition module 158 recognizes that a status of the electric device is changed from a first status to a second status according to the first normalized power feature and the second normalized power feature.

The mechanism of adjusting the power features to the normalized power features and the mechanism of recognizing the status of the electric device are already elaborated with reference to FIG. 2 hereinbefore, and therefore no further description is provided below.

### Second Exemplary Embodiment

The second exemplary embodiment is similar to the first exemplary embodiment, and thus only the difference between these two exemplary embodiments is described herein. In the first exemplary embodiment, the electrical load 170 is installed in normal household. However, in other exemplary embodiments, the electrical load 170 may be configured in a residential district in urban area, a residential district in suburbs, a business district, or an industrial district. In different areas, the type of the power supply 190 may be different, thereby resulting different voltages or different phases. For instance, the power supply in the residential district may be single-phase electric power. In the business district or the industrial district, the power supply may be three-phase electric power. When the power feature is to be measured, a home appliance manufacturer may exemplarily employ the three-phase electric power, and a normal user may exemplarily utilize the single-phase electric power in the residential district or in suburbs. Accordingly, notwithstanding the same electrical load of the electric device, the measured result of the power feature may be different in different environment. From another perspective, when the power feature is to be measured, the type of the power feature meter 180 may be different as well. For instance, according to a coupling relationship between the power feature meter 180 and the electric device, the power feature meter 180 may at least be categorized into a branch meter or a total meter. The total meter is coupled to a master electrical box for measuring the power features of the main power circuit (240 V, 208 V, or 220 V) and the sub-power circuits (120 V or 110 V) simultaneously; the branch meter may merely measure the power feature of one single sub-power circuit.

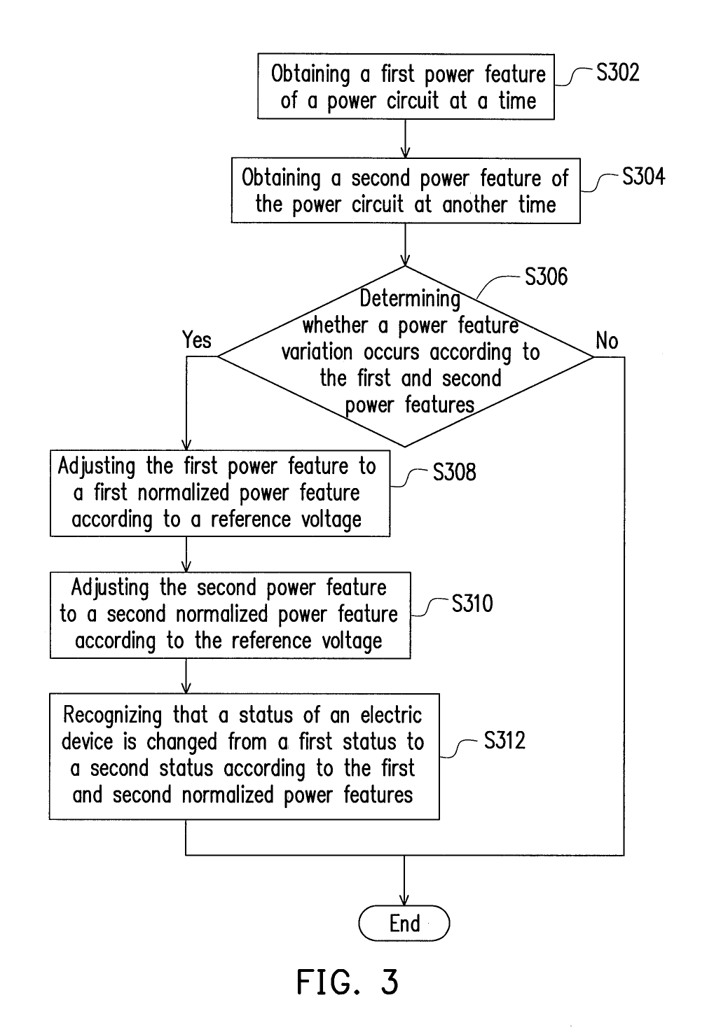

FIG. 4 is a schematic diagram illustrating a three-phase electric power according to a second exemplary embodiment of the disclosure.

As shown in FIG. 4, when the power feature meter 180 is connected between an end 402 and another end 404, the power feature meter 180 measures a phase voltage 442. When the power feature meter 180 is connected between the end 402 and another end 406, the power feature meter 180 measures a linear voltage 444. The amount of linear current 424 is equal to the amount of phase current 422. In the three-phase electric power, the ends 402 and 404 may be incorporated into one sub-power circuit, and the ends 404 and 406 may be incorporated into another sub-power circuit. The power feature meter 180 may be categorized into a total meter branch meter or total meter a branch meter. The total meter measures the linear voltage 444, and the branch meter measures the phase voltage 442 of one sub-power circuit. The amount of current measured by the total meter is 0.5 times as much as the amount of current measured by the branch meter. Note that the phase level and the voltage value of the phase voltage 442 are different from those of the linear voltage 444. Hence, when the electrical load of one electric device is the phase voltage 442, and the power feature meter is the total meter, the measured power feature is inaccurate.

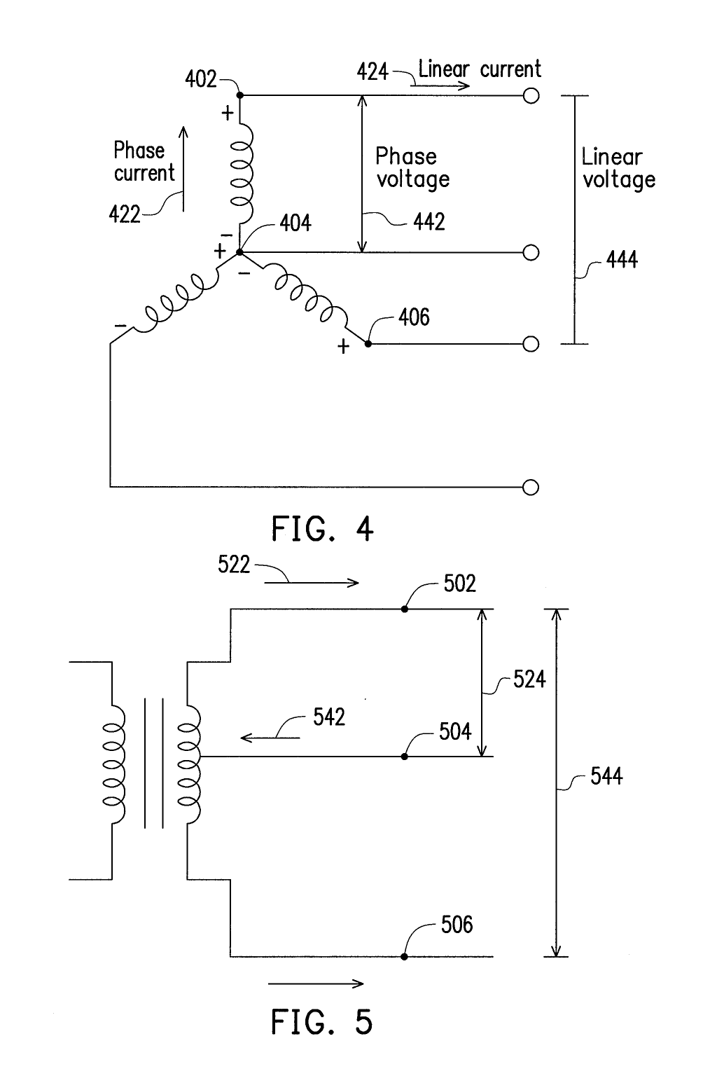

FIG. 5 is a schematic diagram illustrating single-phase electric power according to the second exemplary embodiment of the disclosure.

When the power feature meter 180 is connected between the end 502 and another end 504, the power feature meter 180 measures a voltage 524. When the power feature meter 180 is connected between the end 502 and another end 506, the power feature meter 180 measures a voltage 544. The ends 502 and 504 may be incorporated into one sub-power circuit, and the ends 504 and 506 may be incorporated into another sub-power circuit. Hence, the ends 502, 504, and 506 may constitute a main power circuit. In general, the voltage 544 is approximately 2 times as much as the voltage 524, and the current 542 is approximately 2 times as much as the current 522. In the single-phase electric power, the power feature meter 180 may also be categorized into a branch meter or a total meter. The total meter measures the voltage 544 and the current 522, and the branch meter measures the voltage 524 and the current 542. Hence, when the electrical load is the voltage 524, and the power feature meter is the total meter, the measured power feature is inaccurate.

As described above, both the type of the power supply (e.g., the single-phase electric power or the three-phase electric power) and the type of the power feature meter (e.g., the total meter or the branch meter) may affect the power feature obtained by the power feature meter 180. Therefore, when one power feature of the power circuit 120 is acquired, the power feature extraction module 152 determines the type of the power feature meter 180. Besides, the power feature normalization module 156 determines the type of the power supply 190 according to the location (e.g., the residential district, the business district, or the industrial district) of the power supply 190. Note that the power feature normalization module 156 adjusts the power feature according to the type of the power feature meter, the type of the power supply, and a reference voltage, so as to generate a normalized power feature. The electric device status recognition module 158 then recognizes the electric device according to the normalized power feature.

Particularly, the power feature extraction module 152 obtains a power feature and a voltage of the power circuit 120 through the power feature meter 180. Here, the power feature refers to the active power, the reactive power, or the apparent power, for instance. In an exemplary embodiment, when the power supply 190 is located in a residential district, the power feature normalization module 156 determines that the power supply 190 is the single-phase electric power. At this time, if the power feature extraction module 152 determines that the power feature meter 180 is the total meter, the power feature may be adjusted according to formula (7).

$${P}_{norm} = p \cdot {( \frac{{V}_{ref}}{V / 2} )}^{α} \qquad ( 7 )$$

Here, P is the power feature, and Pₙₒᵣₘ is the normalized power feature. V is the voltage measured by the power feature meter 180, V_{ref} is the reference voltage, and a is the power feature factor.

Namely, the power feature normalization module 156 divides the measured voltage by a predetermined value (e.g., 2) and performs an exponential computation according to the voltage, the reference voltage, and the power feature factor. Eternally, the power feature normalization module 156 multiplies a result of the exponential computation by the power feature to generate the normalized power feature.

By contrast, if the power supply 190 is the single-phase electric power, and the power feature meter 180 is the branch meter, the power feature may be adjusted according to formula (8).

$${P}_{norm} = P \cdot {( \frac{{V}_{ref}}{V} )}^{α} \qquad ( 8 )$$

Here, P is the power feature, and Pₙₒᵣₘ is the normalized power feature. V is the voltage measured by the power feature meter 180, V_{ref} is the reference voltage, and α is the power feature factor.

That is, the power feature normalization module 156 performs the exponential computation according to the measured voltage, the reference voltage, and the power feature factor and multiplies the result of the exponential computation by the power feature to generate the normalized power feature.

In another exemplary embodiment, when the power supply 190 is located in an industrial district or a business district, the power supply 190 is the three-phase electric power. Therefore, the power feature measured by the power feature meter 180 may include the power factor and the apparent power, and the power feature and the normalized power feature are the active power. In the three-phase electric power, the phase level of the linear voltage exceeds the phase level of the phase voltage by 30 degrees; therefore, the power feature normalization module sets one phase difference as 30 degrees and adjusts the apparent power and the power factor according to the phase difference.

For instance, if the power feature meter is the total meter, and the power supply is the three-phase electric power, the power feature normalization module 156 may generate the normalized active power according to formulae (9)-(11).

$$\begin{matrix}{S}_{norm} = S \cdot \frac{2}{\sqrt{3}} & ( 9 ) \\ {PF}_{norm} = cos ( {cos}^{- 1} ( PF ) \pm d ) & ( 10 ) \\ {P}_{norm} = {S}_{norm} \times {PF}_{norm} & ( 11 )\end{matrix}$$

Here, S refers to the apparent power, Sₙₒᵣₘ refers to the normalized apparent power, PF refers to the power factor, PFₙₒᵣₘ refers to the normalized power feature, d denotes the phase difference, and Pₙₒᵣₘ denotes the normalized active power.

Table 1 shows the measured power feature data of one electric device in an exemplary embodiment of the disclosure when the power supply is the three-phase electric power. It can be learned from Table 1 that the active power measured by different power feature meters may be different even though the same electric device is applied.

TABLE 1

| Type of Power | Voltage | Current | Power | Active | Apparent |
|---|---|---|---|---|---|
| Feature Meter | (V) | (A) | Factor | power | Power |
| Total meter | 207.15 | 0.77 | 0.49 | 77.61 | 159.51 |
| Branch meter | 121.69 | 1.55 | 0.85 | 160.06 | 187.7 |

The data measured by the total meter shown in Table 1 may be normalized according to the formulae (9)-(11). The calculation is performed in the following manner.

$${S}_{norm} = 159.51 \times \frac{2}{\sqrt{3}} = 184.19$$

$${PF}_{norm} = cos ( {cos}^{- 1} ( 0.49 ) + 30 ) = 0.86$$

$${P}_{norm} = 184.19 * 0.86 = 158.4$$

By contrast, the data measured by the branch meter shown in Table 1 may be normalized by performing the following calculation.

$${S}_{norm} = 187.7 \times {( \frac{120}{121.69} )}^{2} = 182.5$$

$${P}_{norm} = 160.06 \times {( \frac{120}{121.69} )}^{2} = 155.6$$

Table 2 shows the normalized power feature data obtained by normalizing the power features shown in Table 1 according to an exemplary embodiment of the disclosure. In Table 2, note that the normalized active power obtained by normalizing the power features shown in Table 1 has similar values even though different power feature meters are utilized.

TABLE 2

| | | | | | Normalized |
|---|---|---|---|---|---|
| Power | Voltage | Current | Normalized | Normalized | Apparent |
| Meter | (V) | (A) | Power Factor | Active Power | Power |
| Total | 120 | 1.54 | 0.86 | 158.4 | 184.19 |
| meter | | | | | |
| Branch | 120 | 1.55 | 0.85 | 155.6 | 182.5 |
| meter | | | | | |

In other words, if the power feature meter is the total meter, and the power supply is the three-phase electric power, the power feature normalization module 156 adjusts the apparent power to the normalized apparent power according to the phase difference between the linear voltage and the phase voltage and adjusts the power factor to the normalized power factor according to the phase difference. The power feature normalization module 156 then multiplies the normalized apparent power by the normalized power factor to generate the normalized active power and sets the normalized active power to be the normalized power feature. Thereby, when different types of power feature meters and different types of power supplies are employed to recognize the electric device, the power feature normalization module 156 is able to ensure the consistency of the power features.

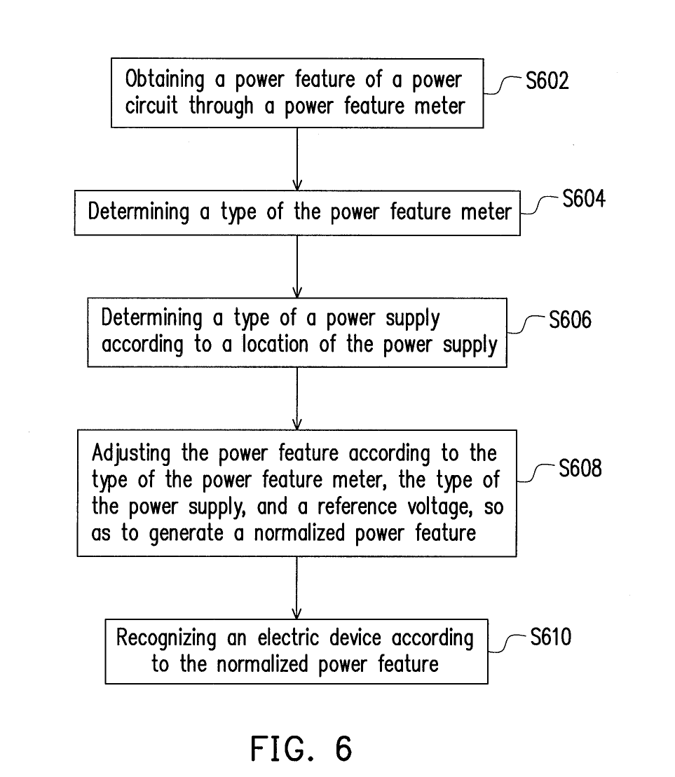

FIG. 6 is a flowchart illustrating a method for monitoring an electrical load of an electric device according to the second exemplary embodiment of the disclosure.

With reference to FIG. 6, in step S602, the power feature extraction module 152 obtains the power feature of the power circuit through the power feature meter. In step S604, the power feature extraction module 152 determines a type of the power feature meter 180. In step S606, the power feature normalization module 156 determines a type of the power supply according to a location of the power supply. In step S608, the power feature normalization module 156 adjusts the power feature according to the type of the power feature meter, the type of the power supply, and a reference voltage, so as to generate a normalized power feature.

In step S610, the electric device status recognition module 158 recognizes the electric device according to the normalized power feature. For instance, the electric device status recognition module 158 may recognize the electric device by performing steps shown in FIG. 3. However, in step S610, the electric device status recognition module 158 may also recognize the electric device in a different manner, which should not be construed as a limitation to the disclosure.

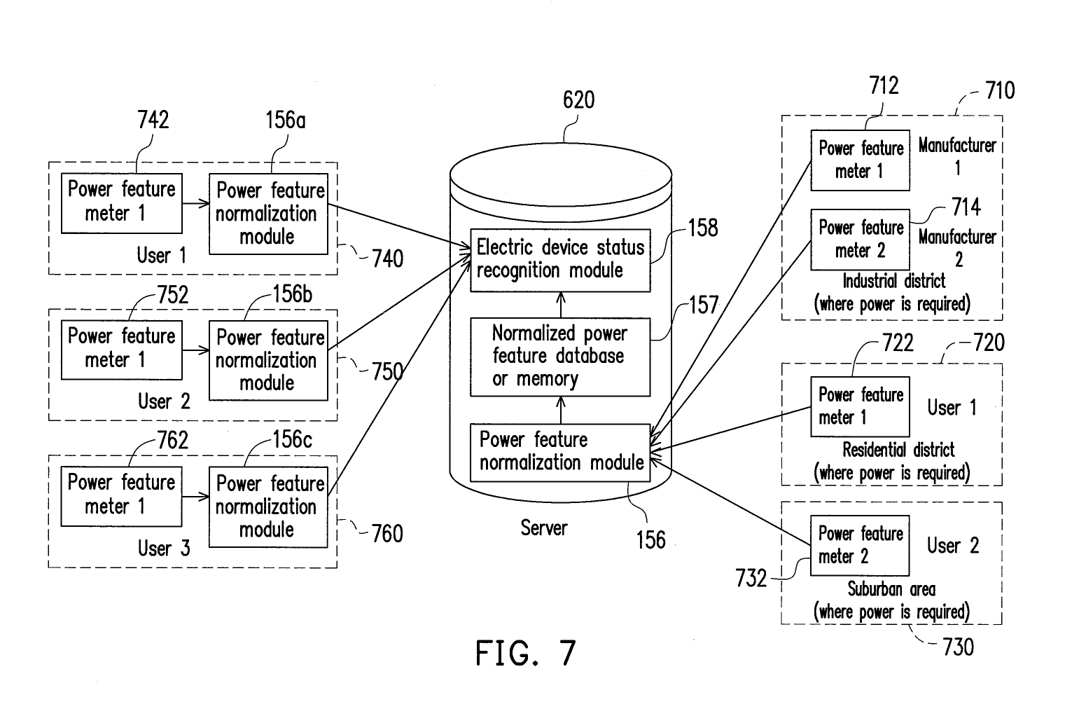

FIG. 7 is a schematic diagram illustrating extraction of the power features from different locations according to the second exemplary embodiment of the disclosure.

With reference to FIG. 7, the server 620 is equipped with the electric device status recognition module 158, the memory 157 (storing a normalized power feature database), and a power feature normalization module 156. The server 620 may obtain power features from an industrial district 710 (where power is required), a residential district 720 (where power is required), a suburban area 730 (where power is required), and users 740, 750, and 760. Since the areas from which the server 620 obtains power are different, the power supply may be different as well. For instance, the power supply in the industrial district 710 is the three-phase electric power suitable for a home appliance manufacturer. The power supply in the residential district 720 is 220 V. The power supply in the suburban area 730 is 240 V suitable for a normal user. After obtaining the power features from the areas, the power feature meters 712, 714, 722, and 732 transmit the obtained power features to the power feature normalization module 156. The electric device status recognition module 158 compares the power features to those stored in the normalized power feature database in the memory 157, so as to recognize the status change of certain electric devices.

From another perspective, the user 740 may also obtain the power feature of a specific electric device through the power feature meter 742 and normalize the power feature through the power feature normalization module 156a. Similarly, the power feature normalization module 156b also normalizes the power feature obtained by the power feature meter 752; the power feature normalization module 156c normalizes the power feature obtained by the power feature meter 762. The power feature normalization modules 156a-156c transmit the normalized power features to the electric device status recognition module 158. The electric device status recognition module 158 then recognize the status change of certain electric devices according to the normalized power feature database in the memory 157.

To sum up, in the method and the system for monitoring the electrical load of the electric device described in the exemplary embodiments of the disclosure, the power feature may be obtained by the power feature meter and normalized according to the location of the power supply and the type of the power feature meter, and the normalized power feature may be transmitted to the server through the power feature meter, processed by the power feature normalization module, and stored in the normalized power feature database or in the memory, as shown in FIG. 7. As to the normal user, the power feature measured by the power feature meter is processed by the power feature normalization module and then transmitted to the electric device status recognition module, so as to recognize the status of the electric device. The normalized power feature may be processed at the server end or the local end of the user, which should not be construed as a limitation to the disclosure. Moreover, when the status of a certain electric device is changed, the different voltages before and after the status change are used for normalizing the power feature. Thereby, the accuracy of recognizing the electric device may be improved, and the electric device may be further monitored properly.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A method for monitoring a plurality of electric devices coupled to a power circuit, the method comprising:
obtaining a first power feature of the power circuit at a first time;
obtaining a second power feature of the power circuit at a second time, wherein the first time is different from the second time;
determining whether a power feature variation occurs according to the first power feature and the second power feature; and
if the power feature variation occurs, performing a recognition process comprising:
adjusting the first power feature to a first normalized power feature according to a reference voltage;
adjusting the second power feature to a second normalized power feature according to the reference voltage; and
recognizing that a status of a first electric device among the electric devices is changed from a first status to a second status according to the first normalized power feature and the second normalized power feature.

2. The method as recited in claim 1, wherein the step of determining whether the power feature variation occurs according to the first power feature and the second power feature comprises:
obtaining a difference between the first power feature and the second power feature;
determining if the difference is greater than a threshold value; and
if the difference is greater than the threshold value, determining that the power feature variation occurs.

3. The method as recited in claim 1, wherein the step of adjusting the first power feature to the first normalized power feature according to the reference voltage comprises:
obtaining a first voltage of the power circuit at the first time;
obtaining a first ratio of the first voltage to the reference voltage;
obtaining a power feature factor;
performing an exponential computation according to the first ratio and the power feature factor; and
multiplying a result of the exponential computation by the first power feature to generate the first normalized power feature.

4. The method as recited in claim 1, wherein the step of adjusting the second power feature to the second normalized power feature according to the reference voltage comprises:
obtaining a second voltage of the power circuit at the second time;
obtaining a second ratio of the second voltage to the reference voltage;
obtaining a power feature factor;
performing an exponential computation according to the second ratio and the power feature factor; and
multiplying a result of the exponential computation by the second power feature to generate the second normalized power feature.

5. The method as recited in claim 3, wherein the step of obtaining the power feature factor comprises:
obtaining a plurality of measured power features and a plurality of measured voltages of a second electric device among the electric devices;
establishing a regression model according to one of the measured power features, one of the measured voltages, the reference voltage, a regression power feature of the second electric device, and the power feature factor; and
performing a regression analysis based on the regression model, the measured power features, and the measured voltages to obtain the power feature factor and the regression power feature.

6. The method as recited in claim 1, wherein the step of recognizing that the status of the first electric device is changed from the first status to the second status according to the first normalized power feature and the second normalized power feature comprises:
establishing a database, wherein the database stores an electric device normalized power feature of each of the electric devices at the reference voltage;
calculating a difference between the first normalized power feature and the second normalized power feature; and
comparing the difference to each of the electric device normalized power features to recognize that the status of the first electric device is changed from the first status to the second status.

7. The method as recited in claim 1, the power circuit comprising a plurality of sub-power circuits, the electric devices being coupled to one of the sub-power circuits, the sub-power circuits being coupled to a multiplexer,
wherein the step of obtaining the first power feature of the power circuit at the first time comprises:
obtaining a sub-power feature of each of the sub-power circuits through the multiplexer; and
obtaining the first power feature according to the sub-power features.

8. The method as recited in claim 1, wherein each of the first power feature and the second power feature respectively comprises a voltage, a current, an active power, a reactive power, a power factor, an apparent power, a current waveform, or a harmonic wave.

9. A method for monitoring an electric device coupled to a power circuit, the power circuit being coupled to a power supply, the power supply being configured for supplying power to the electric device, the method comprising:
obtaining a power feature of the power circuit through a power feature meter;
determining a type of the power feature meter;
determining a type of the power supply according to a location of the power supply;
adjusting the power feature according to the type of the power feature meter, the type of the power supply, and a reference voltage to generate a normalized power feature; and
recognizing the electric device according to the normalized power feature.

10. The method as recited in claim 9, wherein the step of determining the type of the power feature meter comprises:
determining whether the power feature meter is a branch meter or a total meter according to a coupling relationship between the power feature meter and the power supply.

11. The method as recited in claim 10, wherein the power feature further comprises a voltage, and
the step of adjusting the power feature according to the type of the power feature meter, the type of the power supply, and the reference voltage to generate the normalized power feature comprises:
if the power feature meter is the branch meter and the power supply is a single-phase electric power, dividing the voltage by a predetermined value, performing an exponential computation according to the voltage, the reference voltage, and a power feature factor, and multiplying a result of the exponential computation by the power feature to generate the normalized power feature; and
if the power feature meter is the total meter and the power supply is the single-phase electric power, performing the exponential computation according to the voltage, the reference voltage, and the power feature factor and multiplying a result of the exponential computation by the power feature to generate the normalized power feature.

12. The method as recited in claim 10, wherein the power feature comprises a power factor and an apparent power, and
the step of adjusting the power feature according to the type of the power feature meter, the type of the power supply, and the reference voltage to generate the normalized power feature comprises:
if the power feature meter is the total meter and the power supply is three-phase electric power, adjusting the apparent power according to a phase difference between a linear voltage and a phase voltage of the three-phase electric power, so as to generate a normalized apparent power, adjusting the power factor according to the phase difference, so as to generate a normalized power factor, multiplying the normalized apparent power by the normalized power factor to generate a normalized active power; and setting the normalized active power to be the normalized power feature.

13. A system for monitoring a plurality of electric devices, the system being coupled to a power circuit, the electric devices being coupled to the power circuit, the system comprising:
a power feature extraction module configured to obtain a first power feature of the power circuit at a first time and obtain a second power feature of the power circuit at a second time, wherein the first time is different from the second time;
an event detection module coupled to the power feature extraction module and configured to determine whether a power feature variation occurs according to the first power feature and the second power feature;
a power feature normalization module coupled to the event detection module, wherein if the power feature variation occurs, the power feature normalization module is configured to adjust the first power feature to a first normalized power feature according to a reference voltage and adjust the second power feature to a second normalized power feature according to the reference voltage; and
an electric device status recognition module coupled to the power feature normalization module and configured to recognize that a status of a first electric device of the electric devices is changed from a first status to a second status according to the first normalized power feature and the second normalized power feature.

14. The system as recited in claim 13, wherein the power feature normalization module is further configured to obtain a difference between the first power feature and the second power feature and determine whether the difference is greater than a threshold value, and
if the difference is greater than the threshold value, the power feature normalization module identifies that the power feature variation occurs.

15. The system as recited in claim 13, wherein the power feature normalization module is further configured to obtain a first voltage of the power circuit at the first time, obtain a first ratio of the first voltage to the reference voltage, and obtain a power feature factor,
wherein the power feature normalization module is further configured to perform an exponential computation according to the first ratio and the power feature factor and multiply a result of the exponential computation by the first power feature to generate the first normalized power feature.

16. The system as recited in claim 13, wherein the power feature normalization module is further configured to obtain a second voltage of the power circuit at the second time, obtain a second ratio of the second voltage to the reference voltage, and obtain a power feature factor,
wherein the power feature normalization module is further configured to perform an exponential computation according to the second ratio and the power feature factor and multiply a result of the exponential computation by the second power feature to generate the second normalized power feature.

17. The system as recited in claim 15, wherein the power feature extraction module is further configured to obtain a plurality of measured power features and a plurality of measured voltages of a second electric device of the electric devices,
wherein the power feature normalization module establishes a regression model according to one of the measured power features, one of the measured voltages, the reference voltage, a regression power feature of the second electric device, and the power feature factor,
wherein the power feature normalization module performs a regression analysis based on the regression model, the measured power features, and the measured voltages to obtain the power feature factor and the regression power feature.

18. The system as recited in claim 13, wherein the electric device status recognition module is further configured to access a database, wherein the database stores an electric device normalized power feature of each of the electric devices at the reference voltage,
and the electric device status recognition module calculates a difference between the first normalized power feature and the second normalized power feature and compares the difference to each of the electric device normalized power features to recognize that the status of the first electric device is changed from the first status to the second status.

19. The system as recited in claim 13, the power circuit comprising a plurality of sub-power circuits, the electric devices being coupled to one of the sub-power circuits, the sub-power circuits being coupled to a multiplexer,
wherein the power feature extraction module is further configured to obtain a sub-power feature of each of the sub-power circuits through the multiplexer and obtain the first power feature according to the sub-power features.

20. The system as recited in claim 13, wherein each of the first power feature and the second power feature respectively comprises a voltage, a current, an active power, a reactive power, a power factor, an apparent power, a current waveform, or a harmonic wave.

21. The system as recited in claim 13, wherein the electric device status recognition module is further configured for offering a use management to the electric devices.

22. A system for monitoring an electric device coupled to a power circuit, the power circuit being coupled to a power supply, the power supply being configured for supplying power to the electric device, the system comprising:
a power feature extraction module configured to obtain a power feature of the power circuit through a power feature meter and determine a type of the power feature meter;
a power feature normalization module coupled to the power feature extraction module and configured to determine a type of the power supply according to a location of the power supply and adjust the power feature according to the type of the power feature meter, the type of the power supply, and a reference voltage to generate a normalized power feature; and
an electric device status recognition module coupled to the power feature normalization module and configured to recognize the electric device according to the normalized power feature.

23. The system as recited in claim 22, wherein the power feature extraction module is further configured to determine whether the power feature meter is a branch meter or a total meter according to a coupling relationship between the power feature meter and the power supply.

24. The system as recited in claim 23, the power feature further comprising a voltage,
wherein if the power feature meter is the branch meter and the power supply is a single-phase electric power, the power feature normalization module is further configured to divide the voltage by a predetermined value, performing an exponential computation according to the voltage, the reference voltage, and a power feature factor, and multiplying a result of the exponential computation by the power feature to generate the normalized power feature, and
if the power feature meter is the total meter and the power supply is the single-phase electric power, the power feature normalization module is further configured to perform the exponential computation according to the voltage, the reference voltage, and the power feature factor and multiply the result of the exponential computation by the power feature to generate the normalized power feature.

25. The system as recited in claim 23, the power feature comprising a power factor and an apparent power,
wherein if the power feature meter is the total meter and the power supply is a three-phase electric power, the power feature normalization module is further configured to adjust the apparent power according to a phase difference between a linear voltage and a phase voltage of the three-phase electric power to generate a normalized apparent power and adjust the power factor according to the phase difference to generate a normalized power factor,
and the power feature normalization module is further configured to multiply the normalized apparent power by the normalized power factor to generate a normalized active power and set the normalized active power to be the normalized power feature.

26. The system as recited in claim 22, wherein the electric device status recognition module is further configured to offer a use management to the electric device.
